(19) United States
(12) Patent Application Publication
(10) Pub. No.: US 2002/0199014 A1
(43) Pub. Date: Dec. 26, 2002

(54) Configurable and high-speed content-aware routing method

(75) Inventors: Chu-Shing Yang, Tainan City (TW); Mon-Yen Luo, Donggang Town (TW)

Correspondence Address: LOWE HAUPTMAN GILMAN & BERNER, LLP, Suite 310, 1700 Diagonal Road, Alexandria, VA, 22314, US

(73) Assignee: Accton Technology Corporation

(21) Appl. No.: 10/103,802

(22) Filed: Mar. 25, 2002

Related U.S. Application Data
(60) Provisional application No. 60/278,782, filed on Mar. 26, 2001.

(51) Int. Cl. G06F 15/16; G06F 15/173

(52) U.S. Cl. 709/238; 709/203

(57) ABSTRACT

A content-aware routing method comprising the steps of: providing a Web sever cluster having a Web content for responding a plurality of requests via a network, wherein the sever content has a plurality of sever items each having a name with a variable-length alphabet string; providing a URL table having a plurality of record named with a fixed-length binary string converted form the variable-length alphabet string of the name of the sever items by means of a hash function; receiving a request packet with a object name via a network and retrieving the object name of the request packet; converting the retrieved object name into a retrieved fixed-length binary string by means of the hash function; and comparing the retrieved fixed-length binary string with the fixed-length binary string in the URL table for routing the request packet into the Web server cluster. With the proposed approach in the invention, a content-aware routing mechanism can be configurable so that some complex system policies can be deployed in the server system, and the incoming requests can be correctly routed to the appropriate server at very high speed.

### BACKGROUND OF THE INVENTION

1. Field of the Invention

The present invention generally relates to a content-aware routing method for routing packets on the basis of requested content, and more particularly to a content-aware routing method that can intelligently route web requests at very high speed and provide a reliable and highly manageable Web hosting service on a scalable server cluster.

2. Description of the Related Art

With the popularity of the Internet and the World Wide Web, the desire for using the Web to serve business transactions is increasing at an amazing rate. A successful Web site has become increasingly essential to the business community. However, constructing a successful Web site must cope with many challenging problems. First, a web site must be able to serve thousands of simultaneous client requests and scale to rapidly growing user population. Furthermore, rapid response and 24by-7 availability are mandatory requirements for a Web site as it competes for offering users the best “surfing” experience.

Web server cluster is a popular approach used in a Web site as a way to create scalable and highly available solutions. Given a Web server cluster, a request routing mechanism is needed to dispatch and route the incoming request to the server best suited to respond. The network device or front-end node executed such mechanism usually is called Web switch (or server load balancer) in the Internet parlance. Referring to FIG. 1, it depicts a system diagram of an Internet Web server cluster. The packets of the requests of the client computers 110 are transferred to a Web switch 130 through the Internet and then are routed or switched to the individual sever computer of the Web sever cluster 140 via the Web switch 130.

Over the past few years, several approaches or mechanisms have been proposed to enable such a request routing. Examples include DNS aliasing, TCP connection routing (Layer-4 routing), and HTTP redirection (more information can be found in the paper “Efficient support for content-based routing in web server clusters” by Yang et al, published in Proceedings of the 2nd USENIX Symposium on Internet Technologies and Systems, October 1999, referred to Yang's reference, and the paper “Scalable Web server clustering technologies” by Schroeder et al, published in IEEE Network, May/June 2000 which are all incorporated herein by reference). However, such simple routing schemes are no longer sufficient as the complexity of Web sites and the range of services offered on the site are growing fast. For example, the need of running business on the Internet introduces the necessity of providing guarantee that mission-critical applications will receive priority service. Consequently, we can clearly observe an evolution of such Web switch from its initial role of stateless load distributors into intelligent devices that have finer-grained and intelligent control over the system resource allocated to specific content, users and applications.

As a result, the idea of content-aware routing (or referred as URL-aware routing or layer-7 routing), i.e. routing incoming request based on its requested content, has drawn a large amount of attention recently, both in the academic and commercial communities. The content-aware routing mechanism can offer many potential benefits, such as sophisticated load balancing, QoS (Quality of Service) support, guarantee of session integrity, flexibility in content deployment, etc.

To fully realize these advantages, the web switch first needs the ability to be configured with some kind of content-aware intelligence to enable intelligent request routing, or system policies to meet the different requirements of users, contents, and applications. In addition, it should be able to classify and route the incoming requests based on the stored content-related knowledge at high speed. However, so far the related research on this topic pay very little attention to these issues. Most of already published papers in this area focus on the design and implementation challenges posed by the mechanism itself; the proposed approaches includes delayed-binding, TCP splicing, TCP handoff. Pai et.al. have developed load-balancing policy based on the concept of content-aware routing in the paper “Locality-aware request distribution in cluster-based network servers ” published in Proceedings of the 8th International Conference on Architectural Support for Programming Languages and Operating Systems, October 1998. Other examples include optimization of forwarding data path or switch design.

Furthermore, U.S. Pat. No. 6,304,913 B1, entitled “Internet System And Method For Selecting A Closest Server From A Plurality Of Alternative Servers” issued on Oct. 16, 2001 to Rune, discloses a method and Internet system that attempts to improve response times by automatically selecting for use a server (e.g., mirror server or alternative server) located relatively close to a requesting host. U.S. Pat. No. 6,216,173 B1, entitled “Method And Apparatus For Content Processing And Routing” issued on Apr. 10, 2001 to Jones et al., discloses a method and apparatus for incorporating content processing and content routing intelligence into networks. However, both of these patents, incorporated herein by reference, do not still provide a configurable content-aware routing method to fulfill requests distribution at very high speed in the recent Web sever cluster.

Accordingly, there exist needs for providing a configurable content-aware routing method in Web sever cluster to dispatch and route incoming requests to the node which is most suitable for responding to the incoming requests at high speed.

### SUMMARY OF THE INVENTION

The primary object of the present invention is to provide an efficient content-aware routing method in a Web cluster to dispatch and route incoming requests to the appropriate server

It is another object of the present invention to provide a content-aware routing method in a Web cluster that can be configured with some kind of content-aware intelligence to enable intelligent request routing, or system policies to meet the different requirements of users, contents, and applications.

It is a further object of the present invention to provide a content-aware routing method that can intelligently route web requests at very high speed and provide a reliable and highly manageable Web hosting service on a scalable server cluster.

In order to achieve the objects mentioned hereinabove, the present invention provides a content-aware routing method comprising the steps of: providing a Web sever having a Web content for responding a plurality of requests via a network, wherein the Web content has a plurality of items each having a name (called URL) with a variable-length alphabet string; providing a URL table having a plurality of record named with a fixed-length binary string converted form the variable-length alphabet string of the name of the content items by means of a hash function; receiving a request packet with a object name via a network and retrieving the object name of the request packet; converting the retrieved object name into a retrieved fixed-length binary string by means of the hash function; and comparing the retrieved fixed-length binary string with the fixed-length binary string in the URL table for routing the request packet into the Web server.

According to another aspect of the content-aware routing method of the present invention, the step of providing a Web sever having a Web sever content further includes the step of: organizing the sever content into a directory-based hierarchical structure; converting each of the variable-length alphabet strings of the name of the sever items into a fixed-length item-name binary string by means of the hash function; parsing the sever items to create an internal data structure to illustrate a plurality of hyperlinks between the items; converting each of hyperlink names embedded in the hyperlinks into a fixed-length hyperlink binary string by means of the hash function to correspond to the fixed-length item-name binary string; and prefixing a predeterminated string to the hyperlink binary string.

According to still another aspect of the content-aware routing method of the present invention, the step of providing a Web sever having a Web content further includes the step of: modifying the sever items; and restoring the sever content by way of the internal data structure.

Accordingly, the present invention discloses an integrated framework to address the challenges faced by hosting Web content on a server cluster environment. To address the challenges, an internal data structure termed URL (Uniform Resource Locator) table is devised to hold the comprehensive content-related information, which can facilitate the implementation of the rather complex policy for the content-aware system. An approach also is devised to perform fast lookup in this table for searching routing information to make routing decision. In addition, we propose a mechanism termed “URL Formalization” is proposed to further speedup the request routing decision. The result of performance evaluation shows that the proposed approaches can perform content-aware routing at very high speed.

### BRIEF DESCRIPTION OF THE DRAWINGS

Other objects, advantages, and novel features of the invention will become more apparent from the following detailed description when taken in conjunction with the accompanying drawings.

FIG. 1 is a system diagram of a Web server cluster according to the prior art.

FIG. 2 is a system diagram diagrammatically showing the procedure of content placement according to the present invention.

FIG. 3 is a system diagram diagrammatically showing the procedure of content management system according to the present invention.

FIG. 4 is an exemplary Web page according to the present invention.

FIGS. 5 and 6 are bar graphs showing the characteristics of URL in exemplary requests.

FIG. 7 is a bar graph showing the result of the processing time of the approach in the prior art.

### DESCRIPTION OF THE PREFERRED EMBODIMENT

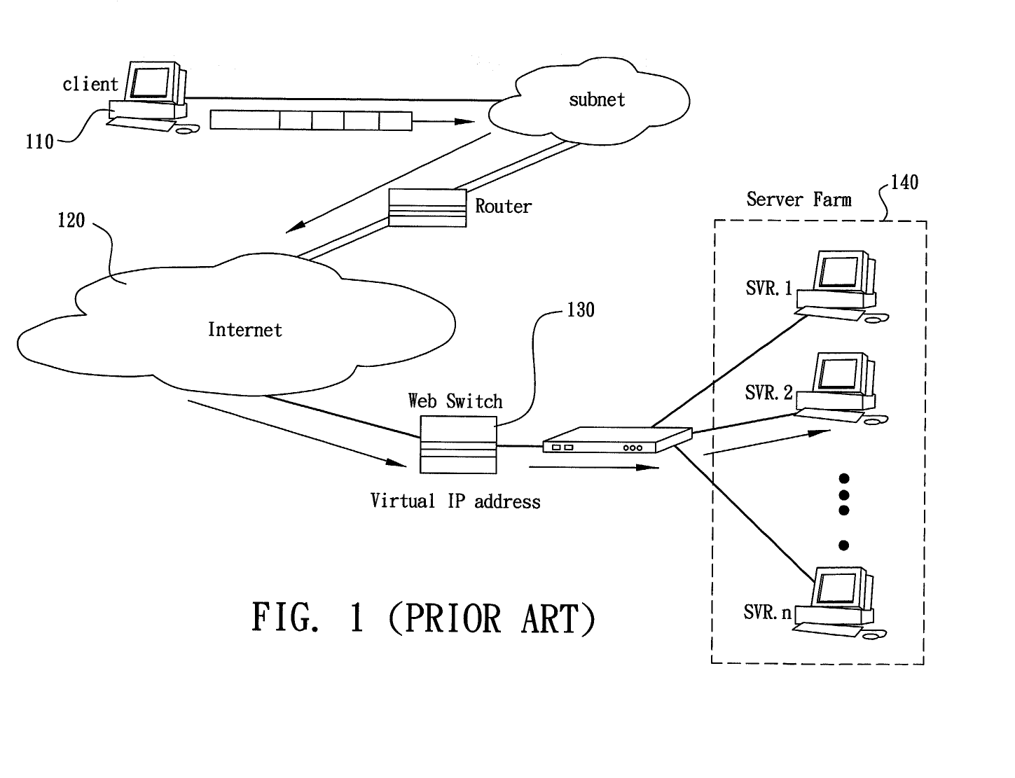

Hereinafter, a content-aware routing method of the preferable embodiment according to the present invention will be described in detail. The content-aware routing method is used for routing or dispatching the requests of the clients from the Internet to the individual sever computer of the Web sever cluster. The system of the Web sever cluster, the clients and the Internet is shown as FIG. 1.

### URL TABLE

First, in the Content-Aware Routing Method (also referred as layer-7 routing mechanism) according to the present invention, certain information can be configured therein to benefit the server system. Therefore, an internal data structure termed URL table is added into the layer-7 routing mechanisms to store the configured information. Finally, the routing method according to the present invention can be performed by means of searching the related information in such the data structure, i.e. URL table.

### Content-aware Intelligence

Generally, the main operation of content-aware routing is to inspect the incoming packets conveying the HTTP request for retrieving some information (e.g., URL, cookie, and host field), and then perform request routing based on such information. The URL is defined to identify a resource of a certain server on the Internet. For example, a URL “http://www.music.com/music/jazz/” identifies that the content in the directory “/music/jazz/” on host “www.music.com” can be accessed via HTTP (Hypertext Transfer Protocol) protocol through the Internet. A client wishing to retrieve such resource should first create a TCP (Transmission Control Protocol) connection to the server and then send an HTTP request including the following request line in its header “. . . Get /music/jazz/ HTTP 1.1 . . . ”, and the remainder of the request follows. The host name “www.music.com” of the URL will be transmitted in a Host header field of the entity-header field, followed behind the request line. To enable a content-aware routing, some content-related knowledge or system policy should be able to be configured into the routing mechanism, so that the properties of the URL in each request can be know and thereby routing this request.

Consequently, in the content-aware routing according to the present invention, the following information can be configured into a content-aware routing mechanism:

Type: this information is used to indicate the type of the content that the URL point to. In modern Web site, the content type can be as varied as static Web pages, dynamic content generated by CGI (Common Gateway Interface) scripts, or transaction-based services, etc. The type information can be used to enable more sophisticated load balancing policy. In contrast, the load-balancing capability provided in many commercial server switches is limited because they do not consider the service type of each request. In addition, such information also can be used to perform request differentiation. We have successfully implemented a low-overhead fault tolerance and QoS (Quality of Service) mechanism based on such a capability. This information also can be used to support session integrity and flexible content placement that can be appreciated in the paper “Efficient content placement and management on cluster-based Web servers” by Yang et al, published in Proceedings of the Seventh IEEE/IFIP Network Operations and Management Symposium, Apr. 10-14, 2000.

Size: For static content, this information indicates the file size of the content; for dynamic content, this information indicates the processing time of generating the content. Such information can be used in some sophisticated load-balancing algorithm.

Priority: This information is used to indicate the priority of the requested content. As the Web has become an important business service delivery infrastructure, the cries for providing service differentiation or QoS support on Web system have become more strident recently. Consequently, fast lookup for identifying the priority of each incoming request is essential in mechanisms that provide QoS support or service differentiation. Using such information, the system manager can create policies for prioritizing traffic from different contents, users, and applications.

Location: This information is used to indicate which nodes possess the content. Such information is necessary when the content is partitioned across the nodes or some nodes are specialized to perform certain operations (e.g., transaction processing, or image manipulation). It can also allow the distribution of selected content, as opposed to the inefficient replicating of all content among traditional server clusters. The system manager can configure the location information to enable only hot content to be replicated for scalability or critical content to be replicated for redundancy. The content-aware routing mechanism can ensure that each request can be routed to the right nodes based on the location information.

### Design of URL Table

Accordingly, the internal data structure termed URL table is added into the request routing mechanism according to the present invention for the organization of the content-related knowledge that quickly can be searched. The URL table according to the present invention is very similar to the idea of routing table in the IP router of the prior art. The IP router maps destination address to next hops according to the routing information in the routing table. When an IP router receives a packet, it must search for which prefixes in its routing table has the longest match when compared to the destination address in the packet. Similarly, in the URL table according to the present invention, when a packet conveying HTTP request arrives, the request routing mechanism looks up in the URL table for searching content-related information that matches some field in the HTTP header, and the best-suited destination server is chosen based on some routing decision algorithm.

It should be understood that the URL table should model the hierarchical structure of the content of a Web site because user generally organizes content using a directory-based hierarchical structure so that the files in the same directory usually possess the same properties. For example, the files underneath the /CGI-bin/ directory generally are CGI scripts for generating dynamic content.

Conceptually, the URL table is a multi-level tree, in which each level corresponds to a level in the content tree and each node represent a file or directory. Each leaf in the tree structure represents a URL. Basically, each item (file or directory) of content in the Web site should have a record corresponding to it in the URL table. However, to reduce the search time and the size of the table, the URL table according to the present invention supports an aggregation mechanism, which can group a set of items that own the same properties (i.e. have the identical routing information) into a single entry. For example, if all items underneath the sub-directory “/html/” are all hosted in the same nodes and have the same content type, only the entry “/html/” exists in the URL table. If the content-aware routing mechanism intends to search the URL table to retrieve information pertained to a URL “/html/misc.html”, it can get the routing information from the node “/html” in the table by just one level search.

### URL Lookup

With the above design, the URL table according to the present invention must be implemented to facilitate a fast lookup. Because each node in the URL table is a variable-length alphabet string, the most common solution to implement such a data structure is using a trie-like (referred to the paper “Trie memory” by Fredkin, published in Communication. Of ACM, vol. 3, pp. 490-500, 1960) data structure that is generally used for storing strings. The basic idea of trie is that each string is represented by a leaf in a tree structure, and the value of the string corresponds to the path from the root of the tree to the leaf. However, basic trie-like data structures have large storage requirement and require multiple (depend on the string length) costly memory access. When implementing a content-aware router according to the preferable embodiment of the present invention, the system performance would be severely degraded if we implement such string searching function in the distributor. As a result, the URL table is implemented in the following way. First, a hash function is used to convert each variable-length string into fixed-length binary string. Then, each binary string is stored in a LC-trie, which is level-compressed version of trie that can enable efficient lookup (referred to the paper “IP-address lookup using LC-tries” by Nilsson et al., published in IEEE Journal on Selected Areas in Communications, VOL. 17, NO. Jun. 6, 1999).

When a packet conveying HTTP header arrives, the content-aware routing mechanism retrieve the URL in the HTTP header, and using the same hash function to convert the URL in to the fixed-length binary string. For example, a URL /entertainment/music/JAZZ/ will be convert to a string composed of 6e70, 4a7f and a7b3 (here, we use hex for convenient expression). Then, the routing mechanism search an entry in the URL table via the approaches mentioned in the Nilsson's paper has the longest match when compared to the binary string.

### PERFORMANCE SPEEDUP

Furthermore, the major problem of the above mechanism is the overhead of retrieving variable-length string and name conversion. This problem derives from the fact that the HTTP header is composed of variable-length strings. As a result, parsing the header to retrieve the necessary information for content-aware routing becomes a considerable burden. Accordingly, a novel mechanism termed URL Formalization is built to further speedup the lookup in the URL table.

The solution to this problem is to make every directory and file of the Web content has a formalized expression. In the sever system according to the present invention, all Web objects, named with normal variable-length string, originally reside on a reliable “home server”, which is also the place where the content owners (i.e. the customer who delegates his content in our Web cluster) manage the content or the authors create them. The document stored on the home server also serves a permanent copy for consistency and robustness. Before these web objects are placed to the server farm (sever cluster), a program will parse the html files and script files (for generating dynamic content) to create an internal data structure called “Object Dependence Graph”. Each node in this graph is a Web object (i.e., html file, graph files such as gif or jpeg files, video clip, etc.), and a directed edge from node A to node B represents a hypertext link in object A that points to object B. Then, a program will use the same hash function described above to convert the original name of every directory and file into a fixed length and formatted name. After that, based on the object dependence graph, another program will modify the embedded hyperlinks of all the html files and script files to conform the new name. For example, if an embedded link points to the URL “http://www.music.com/music/jazz/”, the link should be converted to “http://www.music.com/!!/a967/4a7f/a7b3/”. The name “www.music.com”, “music”, and “jazz” are converted to a formalized name a967, 4a7f, and a7b3 respectively, and the “!!” is a preamble. The preamble is a “magic number”, which is designed to indicate that the following path name is a formalized URL. This also implies that the name of the first level directory is the name of preamble, and all the hosted content should be placed under this directory. The design of the preamble number is important, because we should enable the routing mechanism to know whether the URL of a request is in normal form or formalized form. Finally, the contents are placed to the server nodes in the converted name. But, they also have the original name as an aliasing name, so that a request with regular URL can also access the desired content.

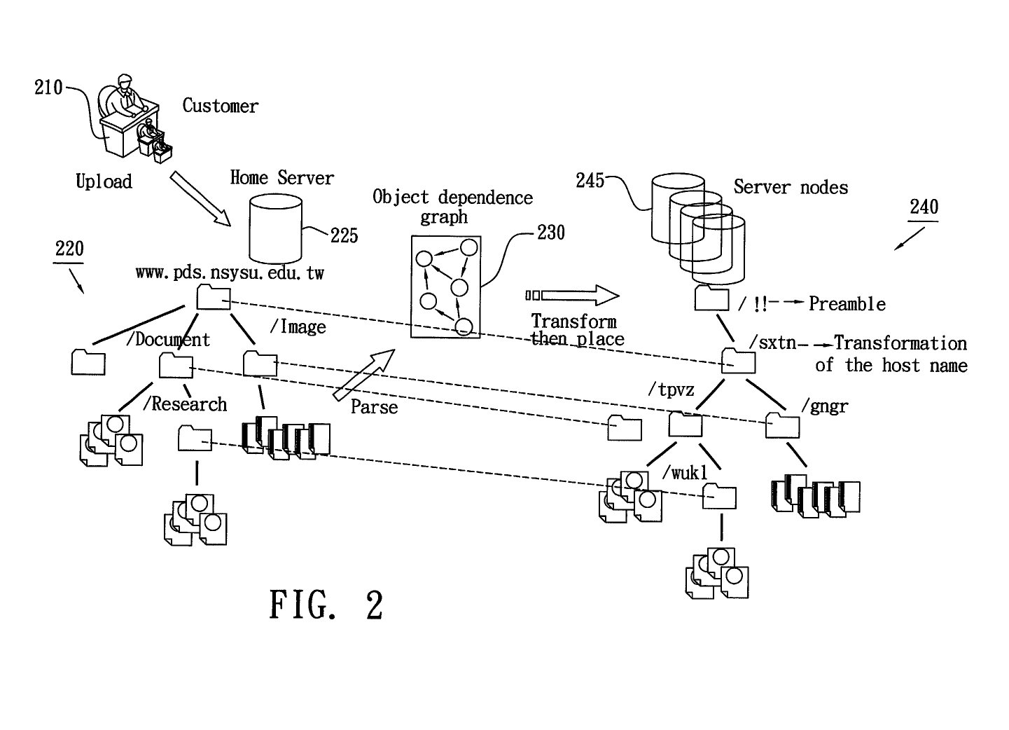

The procedure of content placement according to the present invention is diagrammatically shown in FIG. 2. The customer 210 can upload the Web content 220 named with the normal variable-length string into the home sever 225 as usual. Then, the Web content 220 is parsed and transferred by the object dependence graph 230 into the server nodes 245 to form a formalized content 240 named with the fixed-length binary string.

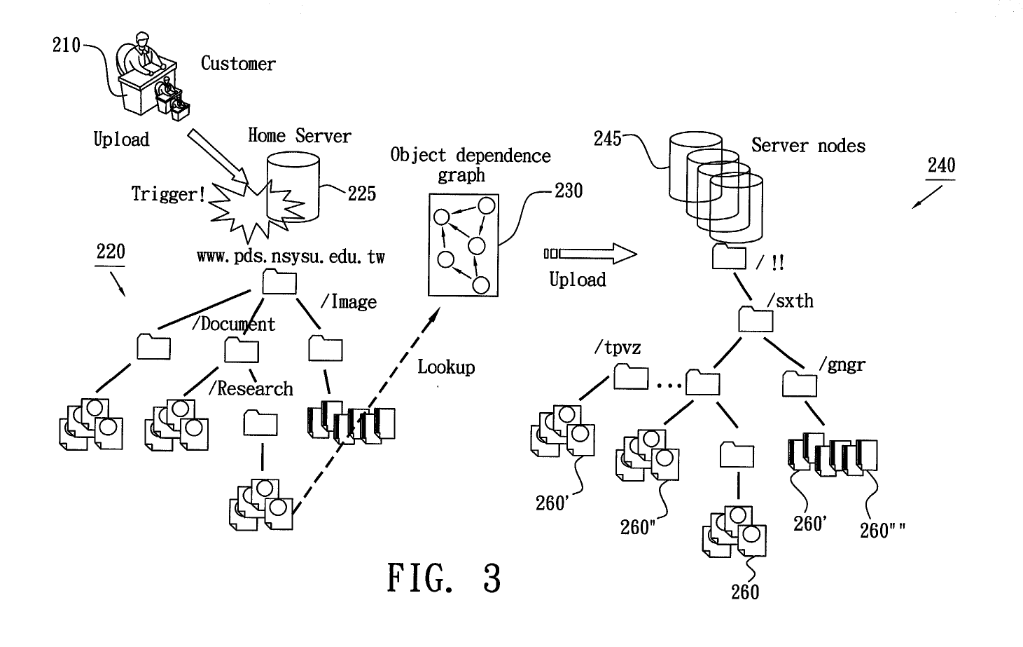

Also, as shown in FIG. 3, a management system for cluster-based Web server systems must be introduced. The management system can provide facilities to mask the complexity of the URL rewriting and the content placement. The operations of parsing and reconstructing the HTML files and scripts files are pre-computed offline. Thus, these operations will not impose any performance penalty on regular operations of the server system and the request routing mechanism. If the content owner or content writer among the customers 210 wants to update or change portion of the content, e.g. a file 250, they can upload the changed file 250 to the home server 6 225. A trigger program is placed in the home server to track such a change. According to the object dependence graph 230, the management system will modify a respondent file 260, as well as the hypertext-linked files 260′, 260″, 260′″, 260′″ etc, of the content 240 in the server nodes 245. Thus, the changes can be effectively propagated to the whole system.

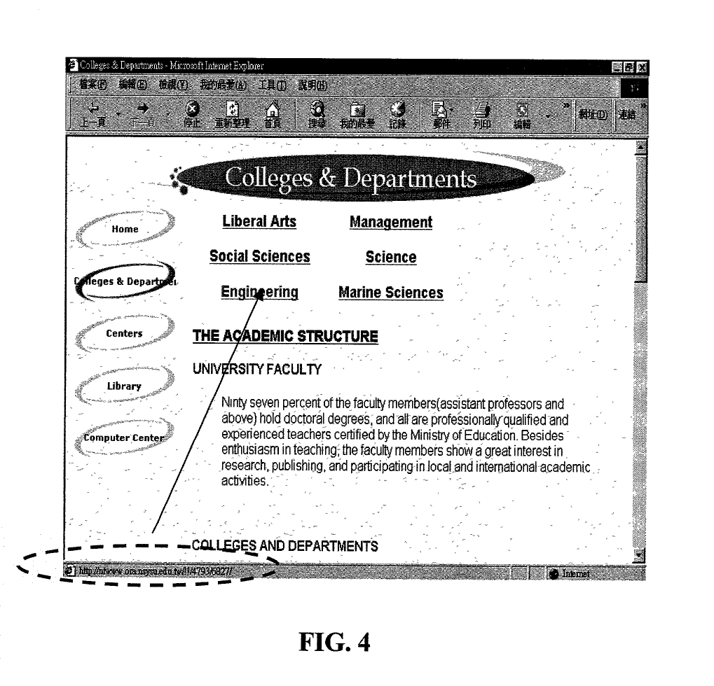

The design of the URL formalization is based on the following observations. Generally, the reason of using a variable-length alphabet string to name a file or directory is just because it is mnemonic, thereby making it easier for humans to remember. However, in most cases an HTTP request is issued when the browser follows a link: either explicitly, when the user clicks on an anchor, or implicitly, via an embedded image or object. That is, most URLs are invisible to the users; they do not care about what name it has. For example, in the web page of FIG. 4, the users only know that he can access the web page of engineering by way of clicking the “Engineering” link, but he dose not care what the URL of this link is. Consequently, the original name can be converted to a formalized form in the manner of user transparency. In our URL-formalization scheme, the URL of the engineering page “http”//www.ora.nsysu.edu.tw/academic/engineering/” will be converted to “http”//www.ora.nsysu.edu.tw/!!/4593/ 6827/” (see the below left of the FIG. 4), where the name “academic” and “engineering” are converted to a formalized name 4593 and 6827 respectively, and the “!!” is preamble.

As a result, if a user clicks the “engineering” link in the web page, his browser will issue an HTTP request with the following request line “Get/!!/4593/6827/ HTTP 1.1 ” in the HTTP header, so that the routing function can process such a request quickly. Combined with the well-designed URL table, the dispatcher or router can quickly retrieve related information from URL to make routing decision. Here, we can clearly see that the major advantage of the present invention is to convert user-friendly names to routing-friendly names. In other words, the fixed-length and formalized names are easier for content-aware routing mechanism to process. We even can implement the content-aware routing function in hardware for further performance boosting.

However, in the relatively infrequent case where users occasionally load Web pages by typing a URL directly. In addition, some dynamic content cannot be rewritten for URL formalization. These cases will issue HTTP requests with a regular URL. That is why the magic number as a preamble is necessary, so that the routing mechanism can distinguish the regular URL from the formalized URL. In case of request with a regular URL, the routing mechanism use the approach of the prior art described above to perform lookup.

Furthermore, the URL formalization approach is particularly useful in the shared Web hosting environment. Since all Web sites in the shared hosting environment are publicized by the same IP address to the external world, the host field is required to identify which Web site the requests is for. This means that the routing mechanism needs to look deeper in the HTTP header (not just the request line) to find the host field. As the HTTP header is composed of variable-length strings, parsing the header to retrieve such information will be a serious burden. To solve this problem, the host name can be moved to the front of the formalized URL. For example, if an embedded link points to the URL “http://www.music.com/music/jazz/”, the link should be converted to “http://www.music.com/!!/a967/4a7f/a7b3/”. The name “www.music.com”, “music”, and “jazz” are converted to a formalized name a967, 4a7f, and a7b3 respectively. As a result, the routing mechanism can quickly identify a request is looking for content of which web site.

### PERFORMANCE RESULT

Now, an exemplary Internet server cluster according to the present invention is maintained for testifying. A Pentium-2 machine (350 MHz CPU with 128 MB memory) running Linux is used to execute the content-aware routing mechanism implemented in the prior art of the Yang's reference and the approaches according to the present invention. The server cluster consists of the following machines: four Pentium Pro machines (200 MHz CPU with 64 MB memory), six Pentium-2 machines (300 MHz CPU with 128 MB memory), and six Pentium-3 machines (1300 MHz CPU with 512 MB memory). Some of the back-end servers run Windows NT with IIS, and the others run Linux with Apache. The reason for using such a software configuration is to show that the mechanism according to the present invention could operate with any kind of operating system and server software.

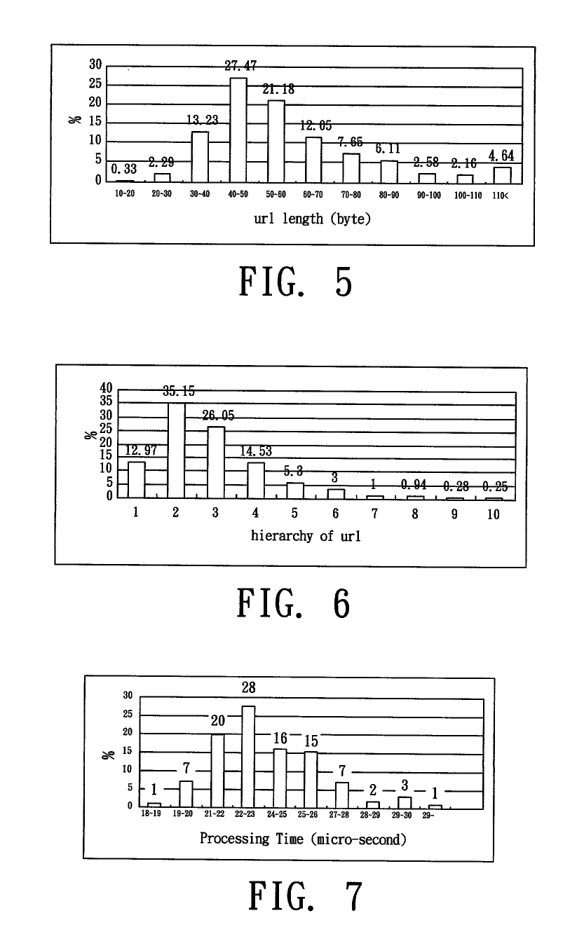

The content hosted in the cluster system consist of 107 Web sites (with approximately 76000 unique files of which the total size is about 1462 MB). In such scale, the memory consumed by the URL table is about 540 Kbytes. For the purpose of performance analysis, the packet level traces (by tcpdump) of the web traffic had been collected to and from our server system for about four months. The log consists of over 200 million HTTP requests. The characteristics of URL in these requests are presented in FIGS. 5 and 6. Then, the log is replayed to evaluate the processing time (i.e., parsing time+lookup time) of the approaches according the present invention.

First, the processing time of the approach in prior art (termed basic mode) was measured. The result is given in FIG. 7. It was found that over 86% lookups can be completed by just two level searches, and almost 100% lookups can be completed by three level searches. Compared with the data in FIG. 6, which shows that over 50% URL is larger than three levels, the benefit of the aggregation technique can be clearly shown. Please notice that most of the processing time shown in FIG. 7 comes from the need to search for host field in the HTTP header. We have performed another experiment in a single web site (not in the shared hosting environment), which showed that the average processing time is about 11.12 msec. This means that our basic mechanism can perform 97000 URL lookups per second.

Then, the processing time of the URL formalization approach is measured. The processing time was consistently between 1˜2.5 msec. A summary of the comparison between the basic mode and URL formalization is given in table 1. Based on these results, it can be appreciated that the URL formalization improves the performance significantly. The reason for the higher performance is because of the clever design of URL formalization and its associated data structure. In particular, the request routing mechanism can quickly identify that the incoming request is for which Web site, rather than parse the entire HTTP header to find out the host field. A variant of Boyer-Moore string matching algorithm, referred to the paper “On improving the worst case running time of the Boyer-Moore string searching algorithm” by Galil, published in Communications of the ACM, vol. 22, no. 9, pp. 505-508, 1979, is used in the basic mode to search the host field, and Galil showed that the algorithm performs O(n) comparisons, where n is the length of the text. In contrast, our approach provide O(1) performance. Combined with the well-designed URL table, our content-aware routing mechanism can quickly retrieve comprehensive information to make routing decision.

To the best of our knowledge, the method according to the present invention is the first trial to deal with the issue of reducing the complexity of content-aware routing. Some vendors have found that the URL paring is necessary, and however, it is very expensive. A technical report from F5 lab indicated that you will loss ⅞ths of your Web switch's performance if you turn on its URL parsing function. The method according to the present invention provides the first solution to this problem.

TABLE 1
Performance benefit of URL formalization

| | Basic Mode | URL Formalization |
|---|---|---|
| 2 level searches | 24.85 msec | 1.12 msec |
| 3 level searches | 28.78 msec | 1.78 msec |

Conclusion

it is understood that the future network devices will need to handle at least some traffic based on application layer information. Content-aware routing is the most important application in such a trend. However, high performance content-aware routing requires a mechanism for very efficient URL parsing and lookup. In addition, comprehensive content-related knowledge and system policies should be able to be embedded into the routing mechanism. In this invention, we provide our solutions to address these issues. Furthermore, it will be appreciated that lots of content-related information can be embedded into the routing mechanism, which can greatly enhance the capability of the content-aware routing mechanism. While the usefulness of most existing Web server-clustering schemes were constrained by lack of content-aware intelligence, the mechanism according to the present invention will dramatically increase the usefulness of the Web-server clustering technique. The implemented mechanisms have proven that the method according to the present invention can route requests based on the comprehensive information at very high speed.

Although the invention has been explained in relation to its preferred embodiment, it is to be understood that many other possible modifications and variations can be made without departing from the spirit and scope of the invention as hereinafter claimed.

What is claimed is:

1. A content-aware routing method comprising the steps of:
providing a Web sever having a Web content for responding a plurality of requests via a network, wherein the Web content has a plurality of items each having a name with a variable-length alphabet string;
providing a URL table having a plurality of record named with a fixed-length binary string converted form the variable-length alphabet string of the name of the items by means of a hash function;
receiving a request packet with a object name via a network and retrieving the object name of the request packet;
converting the retrieved object name into a retrieved fixed-length binary string by means of the hash function; and
comparing the retrieved fixed-length binary string with the fixed-length binary string in the URL table for routing the request packet into the Web server.

2. The content-aware routing method of claim 1, wherein the Web content has a hierarchical tree structure and the URL table is modeled on the hierarchical tree structure of the Web content.

3. The content-aware routing method of claim 1, wherein the step of providing a Web sever having a Web content further includes the step of:
organizing the Web content into a directory-based hierarchical structure.

4. The content-aware routing method of claim 3, wherein the step of providing a Web sever having a Web content further includes the step of:
converting each of the variable-length alphabet strings of the name of the items into a fixed-length item-name binary string by means of the hash function.

5. The content-aware routing method of claim 4, wherein the step of providing a Web sever having a Web content further includes the steps of:
parsing the Web content to create an internal data structure to illustrate a plurality of hyperlinks between the items of the content;
converting each of hyperlink names embedded in the hyperlinks into a fixed-length hyperlink binary string by means of the hash function to correspond to the fixed-length item-name binary string; and
prefixing a predeterminated string to the hyperlink binary string.

6. The content-aware routing method of claim 5, wherein the step of providing a Web sever having a Web content further includes the steps of:
modifying the items of the Web content; and
restoring the Web content by way of the internal data structure.

7. A Web sever system, comprising:
a plurality of sever nodes for providing a content organizing as a tree structure,
wherein each item of the tree structure has an item name with a variable-length alphabet string and an item alias with a fixed-length binary string converted from the variable-length alphabet string of the item name.

8. The Web sever system of claim 7, wherein the content has a plurality of hyperlinks each having a hyperlink alias with a fixed-length hyperlink binary string prefixed with a predeterminated string, and the fixed-length hyperlink binary string is converted from a variable-length hyperlink alphabet string corresponding to the item name of one of the items for interlinking thereto.

9. The Web server system of claim 8, wherein the content has an internal data structure to trace the hyperlinks for modifying the content.

10. The Web sever system of claim 7, further comprising a router for routing requests from a network to one of the sever nodes by way of the item alias.
